(19) United States
(12) Patent Application Publication
(10) Pub. No.: US 2013/0129806 A1
(43) Pub. Date: May 23, 2013

(54) HARD COATING WITH ERYTHRITOL

(71) Applicants: Bart Cortebeeck, Willebroek (BE); Ronny Leontina Marcel Vercauteren, Beveren (BE)

(72) Inventors: Bart Cortebeeck, Willebroek (BE); Ronny Leontina Marcel Vercauteren, Beveren (BE)

(73) Assignee: Carglil Incorporated, Wayzata, MN (US)

(21) Appl. No.: 13/812,176

(22) PCT Filed: Jul. 12, 2011
(86) PCT No.: PCT/EP2011/003474

§ 371 Date: Jan. 25, 2013

(30) Foreign Application Priority Data
Jul. 27, 2010 (EP) 10007772.6

(51) Int. Cl. A23G 4/06

(52) U.S. Cl. CPC A23G 4/062
USPC 424/440; 427/384; 426/5

(57) ABSTRACT

The present invention relates to a coated product comprising a core and a hard coating surrounding the core, wherein the hard coating is composed of at least one coating layer, which comprises erythritol, maltodextrin and one or more crystallization modifiers, preferably carrageenan.

### FIELD OF THE INVENTION

The present invention relates to a coated product comprising a core and a hard coating surrounding the core, wherein the hard coating is composed of at least one coating layer, which comprises erythritol, maltodextrin and one or more crystallization modifiers, and a process for preparing such a coated product.

### BACKGROUND OF THE INVENTION

Edible products are often enclosed with hard or soft coatings, which allow to improve the visual appearance of or to confer a pleasant taste to a product, to preserve the taste of an edible food for a longer period of time, to maintain a certain moisture content, and to provide a barrier for unpalatable ingredients or for unpleasant odours, which escape from the coated product and/or impair the taste of the coated product.

Hard coatings are conventionally prepared by using panning procedures, which typically work with sucrose. In recent years, advances in coating technique, such as panning, have allowed the use of other carbohydrate materials to be used in the place of sucrose. In particular, efforts have been devoted to developing sugar-free hard coatings for use in edible products since the typically used sugars, such as sucrose, proved to be detrimental for teeth and causes dental caries due to the formation of acids in the oral cavity. Therefore, great efforts have been directed to the development of coatings for edible products that are made of compositions containing sugar substitutes, in particular containing those sugar substitutes that belong to the class of polyol compounds, such as xylitol, sorbitol, lactitol, maltitol, mannitol and erythritol.

One of the compounds that have been suggested as a substitute for sugar in hard coatings is xylitol (see, e.g., U.S. Pat. No. 4,681,766, U.S. Pat. No. 4,786,511 and U.S. Pat. No. 4,828,845). A drawback of xylitol, however, is that it is relatively expensive compared to other polyols that are suited as sugar substitutes.

Sorbitol is another known sugar substitute and one of the most inexpensive polyols. Therefore, considerable efforts were directed to prepare hard coatings using sorbitol to replace at least some of the rather expensive xylitol (see, e.g. U.S. Pat. No. 5,536,511). However, the use of sorbitol is hampered by the fact that it is hygroscopic in nature and does not readily crystallize. A number of methods have been developed for the coating of sorbitol (see, e.g., U.S. Pat. No. 4,238,510, and U.S. pat. No. 4,423,086) or mixtures of sorbitol and xylitol (see, e.g., U.S. Pat. No. 5,536,511). However, the properties of the obtained sorbitol containing coating layers have never been satisfactory. Some of the drawbacks that have been observed in connection with sorbitol coatings are an uneven distribution, a rough surface and an unsatisfactory crunchiness, which may all be attributed to crystallization difficulties that affect the appearance of the final coating, as well as the absence of a cooling effect and the lack of a cost-effective advantage due to the incorporation of only low amounts of sorbitol.

Other polyols that have been used as sugar substitutes in the preparation of hard coatings include lactitol and maltitol (see, e.g., U.S. Pat. No. 4,840,797). However, these polyols need to have a high purity in order to obtain an even crystallization and good quality coatings. A further polyol that may also be used for the preparation of a hard coating is mannitol. However, the use of pure mannitol may be associated with problems in the panning process since the solubility of mannitol is relatively low and, thus, too much of the solvent, such as water, would have to be evaporated.

Another known sugar substitute is erythritol, a natural sugar alcohol that has been approved for use as a sweetener throughout the world. Erythritol is a tetrahydric polyol having the structural formula HOCH2—CHOH—CHOH—CH2OH and is commercially available as a non-hygroscopic crystalline powder. It does not affect blood sugar, does not contribute to tooth decay (dental caries), does not contribute to calories and unlike some other polyols does not cause gastric distress due to its ability to be absorbed by the body. In addition, erythritol is known for its cooling effect.

WO 95/07625 discloses a chewing gum product, which comprises a gum pellet covered by a hard coating containing erythritol. Preferably, the hard coating consists of a co-crystallized mixture of 20% to about 60% by weight erythritol and 40% to about 80% by weight xylitol. However, the appearance of these coatings is often affected by crystallization problems resulting in coatings that have been reported to easily peel off from the core or to have a rough surface or other surface defects. It was further observed that a high quantity of erythritol, i.e. a weight proportion of erythritol to xylitol of 80:20 and 90:10, leads to lumpy, rough surfaces, which is probably a result of crystallization difficulties.

EP 1 057 414 A1 describes a hard coating giving good adhesion to cores of edible, chewable or pharmaceutical components, in particular to a chewing gum core. At least one layer of the hard coating comprises a mixture of sorbitol and erythritol, the erythritol being present in an amount of 1 to 50% by weight of the mixture. However, EP 1 057 414 discloses that it is difficult to use more than 50% by weight erythritol since at such high quantities crystallization problems arise which lead to undesirable rough irregular surfaces.

WO 2009036954 relates to a coated product comprising a core and a hard coating surrounding the core, wherein the hard coating is composed of at least one coating layer, which comprises erythritol and one or more crystallization modifiers.

In view of the above, the object of the present invention is to provide further coated products having hard coatings based on a sugar substitute, wherein the hard coatings are further improved with regard to crystallization and exhibit favourable properties.

### SUMMARY OF THE INVENTION

The current invention relates to a coated product comprising a core and a hard coating surrounding the core, wherein the hard coating includes at least one coating layer, which comprises at least 85% erythritol by weight of the at least one coating layer, maltodextrin and one or more crystallization modifiers selected from a group consisting of microbial gums, agar agar, pectin, alginic acid, sodium alginate, beta-glucans, carrageenan, glucomannan, guar gum, gum ghatti, gum tragacanth, karaya gum, tara gum, fenugreek gum, locust bean gum, and mixtures of two or more thereof, preferably carrageenan. It further relates to a process for preparing such hard coating.

### DETAILED DESCRIPTION

The current invention relates to a coated product comprising a core and a hard coating surrounding the core, wherein the hard coating includes at least one coating layer, which comprises at least 85% erythritol by weight of the at least one coating layer, maltodextrin and one or more crystallization modifiers selected from a group consisting of microbial gums, agar agar, pectin, alginic acid, sodium alginate, beta-glucans, carrageenan, glucomannan, guar gum, gum ghatti, gum tragacanth, karaya gum, tara gum, fenugreek gum, locust bean gum, and mixtures of two or more thereof, preferably carrageenan.

Erythritol is a carbohydrate-based polyol (sugar alcohol), i.e. a tetriitol represented by the chemical formula C₄H₁₀O₄ and which has an excellent appearance in the form of white crystals and it is similar to the appearance of granulated sugar, sucrose. It is highly soluble in water, non-digestive, providing zero calories and is non cariogenic. It is obtainable via microbial processes or fermentation or chemical processes, usually other than hydrogenation of carbohydrates, preferably via fermentation. Any grade of erythritol is suitable and without any limitation. A suitable source of erythritol is a micronized erythritol prepared as described in WO2009016133, or a fine grade of erythritol, or preferably turbomilled erythritol and the like. Mixtures of different grades can be applied as well.

The erythritol constitutes at least 85% by weight, preferably 90% by weight, of the at least one coating layer, more preferably in an amount of 94% by weight of the at least one coating layer.

Maltodextrin consists of D-glucose units predominantly linked with α(1→4) glycosidic bonds and is classified by DE (dextrose equivalent) between 3 to 20. Typically maltodextrin is composed of a mixture of chains that vary from three to twenty glucose units long and it is produced from starch by partial hydrolysis. Maltodextrin is present in an amount of from 1% to 12% by weight of the at least one coating layer.

One or more crystallization modifiers are added and are selected from a group consisting of microbial gums, agar agar, pectin, alginic acid, sodium alginate, beta-glucans, carrageenan, glucomannan, guar gum, gum ghatti, gum tragacanth, karaya gum, tara gum, fenugreek gum, locust bean gum, and mixtures of two or more thereof, preferably carrageenan.

The term “microbial gums”, as used herein, is intended to mean all gum polysaccharides of microbial origin, i.e. from algae, bacteria or fungi. Examples thereof include, for example, gellan and xanthan gums that are both produced by bacteria. A preferred microbial gum for use herein is xanthan gum, a microbial desiccation resistant polymer prepared commercially by aerobic submerged fermentation. Xanthan is an anionic polyelectrolyte with a β-(1,4)-D-glucopyranose glucan backbone having side chains of (3,1)-α-linked D-mannopyranose-(2,1)-β-D-glucuronic acid-(4,1)-β-D-mannopyranose on alternating residues.

The repeating unit of gellan is a tetrasaccharide which consists of two residues of D-glucose and one of each residues of L-rhamnose and D-glucuronic acid. The tetrasacharide repeat has the following structure: [D-Glc(β1→4)D-GlcA(β1→4)D-Glc(β1→4)L-Rha(α1→3)]n. As it is evident from the formula the tetrasacharide units are connected with each other using an (α1→3) glycosidic bond.

Agar agar is a plant-derived gum polysaccharide The gelling agent is an unbranched polysaccharide obtained from the cell walls of some species of red algae, primarily from the genera Gelidium and Gracilaria, or seaweed.

Another water-soluble dietary fiber is pectin, which is a heterogenous group of acidic polysaccharides found in fruit and vegetables and mainly prepared from waste citrus peel and apple pomace. Pectin has a complex structure, wherein a large part of the structure consists of homopolymeric partially methylated poly-α-(1,4)-D-galacturonic acid residues with substantial hairy non-gelling areas of alternating α-(1,2)-L-rhamnosyl-α-(1,4)-D-galacturonosyl sections containing branch points with mostly neutral side chains (1 to 20 residues) of mainly L-arabinose and D-galactose. The properties of pectins depend on the degree of esterification, which is normally about 70%. The low-methoxy (LM) pectins are less than 40% esterified, while high-methoxy (HM) pectins are more than 43% esterified, usually 67%.

Alginic acid and sodium alginate are vegetable gums of linear polymers containing β-(1,4)-linked D-mannuronic acid and α-(1,4)-linked L-guluronic acid residues produced by seaweeds.

Beta-glucans which are defined to consist of linear unbranched polysaccharides of linked β-(1,3)-D-glucopyranose units in a random order. Beta-glucans occur, for example, in the bran of grains, such as barley, oats, rye and wheat.

Carrageenan is a generic term for polysaccharides prepared by alkaline extraction from red seaweed. Carrageenan includes linear polymers of about 25,000 galactose derivatives. The basic structure of carrageenan consists of alternating 3-linked β-D-galactopyranose and 4-linked α-D-galactopyranose units. There are three main classes of commercial carrageenan: the kappa, iota and lambda carrageenan.

Glucomannan is mainly a straight-chain polymer, with a small amount of branching. The component sugars are β-(1→4)-linked D-mannose and D-glucose in a ratio of 1.6:1. The degree of branching is about 8% through β-(1→6)-glucosyl linkages.

Guar gum, which is defined as a galactomannan consisting of a α-(1,4)-linked β-D-mannopyranose backbone with branch points from their 6-positions linked to α-D-galactose. It is non-ionic and typically made up of about 10,000 residues. Guar gum is highly water-soluble and, for example, more soluble than locust bean gum.

Gum ghatti is a natural gum obtained from Indian tree, Anogeissus latifolia.

Gum tragacanth is a viscous, odorless, tasteless, water-soluble mixture of polysaccharides obtained from sap which is drained from the root of several species of Middle Eastern legumes of the genus Astragalus, including A. adscendens, A. gummifer, and A. tragacanthus.

Karaya gum, is a vegetable gum produced as an exudate by trees of the genus Sterculia. It is an acid polysaccharide composed of the sugars galactose, rhamnose and galacturonic acid.

Tara gum, is a white or beige, nearly odorless powder that is produced by separating and grinding the endosperm of C. spinosa seeds. The major component of the gum is a galactomannan polymer similar to the main components of guar and locust bean gums.

Fenugreek gum, consists of D-mannopyranose and D-galactopyranose residues with a molar ratio of 1.2:1.0. The main chain of this galactomannan comprises β-(1,4)-linked D-mannopyranose residues, in which 83.3% of the main chain is substituted at C-6 with a single residue of alpha-(1,6)-D-galactopyranose. The galactomannan is made up of about 2,000 residues. Fenugreek gum (seed endosperm) contains 73.6% galactomannan.

Locust bean gum is a galactomannan similar to guar gum. It is polydisperse, non-ionic, and is made up of about 2,000 residues. Locust bean gum is less soluble and less viscous than guar gum and needs heating to dissolve but is soluble in hot water.

It has been unexpectedly and surprisingly found that maltodextrin and the crystallization modifiers described herein allow controlling the crystallization of an erythritol-based hard coating, which is essential in obtaining good hard coatings. More specifically, maltodextrin and the crystallization modifiers used within the context of the present invention result in a fast and even crystallization. The crystallization modifier, preferably carrageenan, is used in an amount of from 0.2% to 3% by weight, in an amount of 0.3% to 2% by weight of the at least one coating layer and it enables the preparation of sugar-free or sugar-reduced erythritol-based hard coatings that adhere well to a given core and exhibit desirable coating properties, such as crunchiness. The hard coatings of the present invention are therefore suitable for a variety of applications, for example for coating pharmaceutical preparations and chewable or edible products.

According to the present invention, the at least one coating layer may further contain one or more additives, such as high-intensity sweeteners, dispersing agents, for example titanium dioxide and talc, colouring agents, film formers, for example gelatin, binding agents, for example gum arabic, and flavouring agents, for example, essential oils or synthetic flavours, as known in the art.

Suitable high-intensity sweeteners, which can be used as non-nutritive sweeteners can be selected from the group consisting of aspartame, acesulfame salts such as acesulfame-K, saccharins (e.g. sodium and calcium salts), cyclamates (e.g. sodium and calcium salts), sucralose, alitame, neotame, steviosides, glycyrrhizin, neohesperidin dihydrochalcone, monellin, thaumatin, brazzein, mixtures of two or more thereof, and the like. Actually any other natural derived high-intensity sweetener is suitable as well.

In a preferred embodiment, the hard coating of the coated product of the present invention comprises more than one coating layer. In a preferred embodiment, the hard coating of the coated product of the present invention is composed of 1 to 100 coating layers, wherein at least one of these coating layers is a coating layer comprising erythritol, maltodextrin and one or more crystallization modifiers and, optionally, one or more additives, as defined above (in the following sometimes referred to as “erythritol-based coating layer”). This is to say, that the other coating may comprise one or more erythritol-based coating layers and one or more layers that are different to the one or more erythritol-based coating layers, wherein the erythritol-based coating layers and the other, different layers may be arranged within the coating in any sequence. Preferably, the coating comprises several, for example 10 to 40, erythritol-based coating layers consecutively disposed upon each other.

Within the coating, the erythritol-based coating layer may be the first layer, which is in direct contact with the core or it may be a layer, which is close enough to the core for effecting good adhesion to the core. For example, the core may be pre-coated with a binder layer of, for example, vegetable gums, maltodextrins, corn syrup, cellulose and cellulose derivatives, starch and starch derivatives and the like, onto which at least one erythritol-based coating layer is applied.

Preferably, the hard coating constitutes from 10 to 80% by weight, more preferably from 20 to 70% by weight, most preferably from 30 to 60% by weight, of the coated product.

The core of the coated product of the present invention is not particularly restricted and may be composed of any coatable material. Preferably, the core is sugar-free. For example, the core may be a product selected from the group consisting of pharmaceutical preparations, such as tablets, chewable products, such as chewing gums, and edible products, such as dietetic products, confectionery products and other food products, such as nuts and dry fruits, for human or animal use. The confectionary products include, for example, chocolate and chocolate containing products, and candies that may be in the form of tablets, lozenges, jellies, chewy pastes and the like. Preferably, the cores as well as the coatings are sugar-free.

Preferably, the core constitutes from 20 to 90% by weight, more preferably 30 to 80% by weight, most preferably from 40 to 70% by weight of the coated product.

According to another aspect, the present invention relates to a process for preparing a coated product having a hard coating according to the present invention. This method comprises the following steps:
(a) providing a coating solution, wherein the coating solution comprises a solvent and a coating mixture comprising erythritol, maltodextrin and one or more of the above-mentioned crystallization modifiers, and wherein the erythritol constitutes at least 85% by weight of the coating mixture;
(b) coating a plurality of centers in a moving-product coating device by applying the coating solution to the plurality of centers, while moving the plurality of centers by means of the moving-product coating device;
(c) drying the applied coating solution to obtain a coated product.

As regards step (a) of the process, the solvent of the coating solution is typically water. However, a person skilled in the art is able to select other appropriate solvents depending on the coating to be produced and the particular process parameters to be used.

Preferably, the coating solution contains 30 to 85% by weight of the coating mixture and 15 to 70% by weight of the solvent. The coating mixture included in the coating solution comprises 85 to 99.9%, preferably 90 to 99%, more preferably 95 to 98% by weight erythritol and 0.1 to 15% of maltodextrin and crystallization modifiers that are mentioned above and wherein the maltodextrin and crystallization modifiers are comprising from 1 to 12% maltodextrin. Preferably 1 to 10%, more preferably 2 to 5% by weight of the one or more crystallization modifiers and maltodextrin is added by weight.

The coating mixture may also include low amounts of additives, including artificial sweeteners, dispersing agents, coloring agents, film formers, binding agents and flavoring agents, as described above. In a variation of the process, these additives may also be added prior to or after application of the coating solution to the moving mass of centers. The flavoring agent, for example, may be added to the coating solution or may be applied while the applied coating layer is drying or after the coating layer has been dried.

In step (b), a plurality of centers is coated by applying the coating solution to the plurality of centers, while moving the plurality of centers using a moving-product coating device. The moving-product coating device may be any device that allows actuating the centers to be coated. Conveniently, the moving-product coating device is a rotating pan. Typically, the coating pan has an ordinary form, i.e. a tulip shape with an inclined axis of rotation or alternatively a cylindrical shape with a horizontal axis. The application of the coating solution to the centers is preferably carried out by spraying an appropriate quantity of the coating solution onto the surface of the moving centers and allowing it to become evenly distributed over the centers.

The centers that are employed in step (b) can be any piece of material independent from its shape and composition, as long as it allows coating at least one erythritol-based coating layer described herein. In particular, the centers can be uncoated cores or pre-coated cores, wherein the cores may be as defined above. The pre-coated cores may already contain one or several coating layers in any sequence that may be the same or different and which may include one or more of the erythritol-based coating layers prepared in accordance with steps (b) and (c) of the process of the present invention. In a preferred embodiment, the center is a core that is pre-coated by a binding layer made of, for example, vegetable gums, maltodextrins, corn syrup, cellulose and cellulose derivatives, starch and starch derivatives and the like.

After having applied the coating solution to the plurality of centers in step (b), the thus obtained coated product is dried in step (c). Conveniently, the drying step may be carried out inside the moving-product coating device by blowing dry and hot air. Preferably, the used drying air has a temperature in the range of 15 to 45° C. and/or a moisture content of at most 50%, preferably at most 30%, relative humidity.

In a preferred embodiment, step (b) of coating the plurality of centers and step (c) of drying the applied coating is repeated as many times a desired, either successively or intermittently to allow adding one or more different coating layers. Typically, the coating and drying steps are repeated 1 to 99, usually 1 to 40 or 1 to 25, in particular 1 to 10 times, to build up a plurality of layers. The specific number and nature of the coating layers will depend on the desired application and can be readily determined experimentally by a person skilled in the art.

The coated product obtained by the process of the present invention may be further treated to provide the coated product with certain desirable characteristics, such as physical and organoleptic properties, and/or increase the product's attractivity. For example, a confectionery product may be provided with a gloss coating by glazing, providing the final product with a brilliant surface and a moisture-barrier.

Providing a hard coating of erythritol and maltodextrin without the addition of crystallisation modifiers was not feasible on industrial scale due to blockage of the heated nozzle.

The coated products wherein the hard coating was prepared from a coating syrup of erythritol and 0.3% kappa-carrageenan were obtained without interruption and the heated nozzle was not blocked. The corners of the coated product though, were less stable than the corners of the coated products prepared with a coating syrup of erythritol, maltodextrin and carrageenan.

The invention will hereunder be illustrated in following examples.

### EXAMPLES

### Example 1

### Preparation of Chewing Gum, Having a Hard Coating, Containing Erythritol, Carrageenan and Maltodextrin

Coating-solution was prepared by mixing 34.8% (w/w) of water, 60.7% (w/w) Erythritol Zerose™ 16957 (Cargill) and 3.2% (w/w) of maltodextrin (C*Dry Mdx 01910, C*Dry Mdx 01955 Cargill Mdx EP 1205, from Cargill) together and heating this mass till 90-95° C. At this temperature 0.6% (w/w) Erythritol Zerose™ 16957 and 0.3% (w/w) Kappa-Carrageenan (Satiagel UME 614 Carraghenane Kappa (Cargill) is added and mass was further heated till boiling. Brix was adjusted, when needed and 0.4% (w/w) TiO2 is added.

The, ready to use, coating-solution was stored and used at 85° C. and 60° Brix.

The nozzle (Spraying systems Co) was heated at 85° C., through warm water and on electrical way.

43 layers were sprayed upon the chewing gum centers and the total amount of liquid sprayed was around 1225 ml. At the start, 2 kg of centers were added to the coating pan (DriaCoater 500/600 Vario). During a coating time of around 4 hr, a coating weight of 25-26%, based on the original weight of the centers, was added.

The drying temperature for the centers was 28° C. at a humidity of 17-17% and an air supply of 3.4 m3/min, and the pan speed was 14 rpm.

The coated chewing gum centers were waxed with Capol 600 (Kaul Gmbh).

The process run very smoothly without blockage of the heated nozzle.

The final products had an even surface, a hard coating and gave upon tasting crunchiness.

The product was very satisfactory in the sense that also the corners of the coated chewing gum were shown to be stable.

### Comparative Example

### Preparation of Chewing Gum, Having a Hard Coating, Containing Erythritol and Maltodextrin

Coating-solution was prepared by mixing 34.6% (w/w) of water, 61.8% (w/w) Erythritol Zerose™ 16957 (Cargill) and 3.2% (w/w) of maltodextrin (C*Dry Mdx 01910, C*Dry Mdx 01955 Cargill Mdx EP 1205, from Cargill) together and heating this mass till boiling. Brix was adjusted, when needed and 0.4% (w/w) TiO2 is added. The following ratio (w/w) was obtained: erythritol 95.0%/maltodextrin 5.0%

The, ready to use, coating-solution was stored and used at 85° C. and 60° Brix.

The nozzle (Spraying systems Co) was heated at 85° C., through warm water and on electrical way.

43 layers were sprayed upon the chewing gum centers and the total amount of liquid sprayed was around 1225 ml. At the start, 2 kg of centers were added to the coating pan (DriaCoater 500/600 Vario). During a coating time of around 4 hr, a coating weight of 25-26%, based on the original weight of the centers, was added.

The process had to be stopped due to a blocked nozzle. The nozzle needed to be cleaned several times with hot water.

The drying temperature for the centers was 28° C. at a humidity of 17% and an air supply of 3.4 m3/min, and the pan speed was 14 rpm.

The coated chewing gum centers were waxed with with Capol 600 (Kaul Gmbh).

It was very hard to obtain the products, since the nozzle was constantly blocked and the process cannot be applied on industrial scale. Moreover, the interruption of the process has a negative effect on the quality of the hard coating.

### Comparative Example Preparation of Chewing Gum, Having a Hard Coating, Containing Erythritol and Carrageenan

Coating solution was prepared by mixing 37% (w/w) of water and 62% (w/w) Erythritol Zerose™ 16957 (Cargill) together and heating this mass till 90-95° C.

At this temperature 0.68% (w/w) Erythritol Zerose™ 16957 and 0.32% Kappa-Carrageenan (Satiagel UME 614 Carraghenane (Cargill) is added and mass was further heated till boiling. Brix was adjusted, and 0.4% (w/w) TiO2 is added.

The, ready to use, coating solution was stored and used at 85° C. and 60° Brix. The solution was stable.

The nozzle (spraying systems Co) was heated at 85° C., through warm water and on electrical way.

34 Layers were sprayed upon the chewing gum centers and the total amount of liquid sprayed was around 1101 ml. At the start, 2 kg of centers were added to the coating pan (Dria coater 500/600 Vario). During a coating time of around 2 h 45′, a coating weight of 31-32%, based on the original weight of the centers, was added.

The drying temperature for the centers was 28° C. at a humidity of 17-27% and an air supply of 3.4 m3/min, and the pan was 8 rpm.

During the process the nozzle did no block.

The coated chewing gum centers were waxed with Capol 600 (Kaul Gmbh).

The final products had an even surface, a hard coating and gave upon tasting crunchiness. Corners of the coated centers where less stable than the corners of the products prepared in example 1.

1.-10. (canceled)

11. A coated product comprising:
a core; and
a hard coating surrounding the core,
wherein the hard coating includes at least one coating layer, the at least one coating layer comprising:
at least 85% erythritol by weight of the at least one coating layer;
maltodextrin; and
a crystallization modifier,
wherein the crystallization modifier is selected from the group consisting of a microbial gum, agar agar, pectin, alginic acid, sodium alginate, beta-glucan, carrageenan, glucomannan, guar gum, gum ghatti, gum tragacanth, karaya gum, tara gum, fenugreek gum, locust bean gum, and mixtures thereof.

12. The coated product of claim 11, wherein the crystallization modifier is carrageenan.

13. The coated product of claim 11, wherein the maltodextrin is present in an amount of from 1% to 12% by weight of the at least one coating layer.

14. The coated product of claim 11, wherein the carrageenan is present in an amount of from 0.2% to 3% by weight of the at least one coating layer.

15. The coated product of claim 11, wherein the erythritol is present in an amount of 90% by weight of the at least one coating layer.

16. The coated product of claim 11, wherein erythritol is present in an amount of 94% by weight of the at least one coating layer.

17. The coated product of claim 11, wherein the hard coating comprises 1 to 100 coating layers.

18. The coated product of claim 11, wherein the core is selected from the group consisting of a pharmaceutical preparation, a chewable product, and an edible product.

19. The coated product of claim 11, wherein the core is a confectionery product.

20. The coated product of claim 11, wherein the at least one coating layer further comprises an additive selected from the group consisting of a high intensity sweetener, a dispersing agent, a coloring agent, a film former, a binding agent, a flavoring agent, and mixtures thereof.

21. A method of preparing the coated product of claim 11, the method comprising:
a) providing a coating solution, wherein the coating solution comprises:
a solvent; and
a coating mixture,
wherein the coating mixture comprises:
erythritol;
maltodextrin; and
a crystallization modifier,
wherein the erythritol constitutes at least 85% by weight of the coating mixture;
b) coating a plurality of cores with the coating solution; and
c) drying the applied coating solution to obtain the coated product.

22. The method of claim 21, wherein the solvent of the coating solution is water.
